(19) United States
(12) Patent Application Publication
(10) Pub. No.: US 2015/0165631 A1
(43) Pub. Date: Jun. 18, 2015

(54) Hair Cutter

(71) Applicants: Shi Wang He, Taichung City (TW); AMIGO SOFT CO., LTD., Taichung City (TW)

(72) Inventors: Shi Wang HE, TAICHUNG (TW); Jia Zhe HE, TAICHUNG CITY (TW); MING TING HE, TAICHUNG CITY (TW); MENG QIAN HE, TAICHUNG CITY (TW)

(73) Assignees: AMIGO SOFT CO., LTD., Taichung City (TW); Shi Wang He, Taichung City (TW)

(21) Appl. No.: 14/108,305

(22) Filed: Dec. 16, 2013

(51) Int. Cl. B26B 27/00

(52) U.S. Cl. CPC B26B 27/00

(57) ABSTRACT

A hair cutter includes a stationary blade and a movable blade. The stationary blade includes a recess near a free end and a cutting edge on an upper side of the recess. The recess is adapted for receiving at least one string of hair. The movable blade includes a cutting edge at a free end. The cutting edge of the movable blade is movable past the cutting edge of the stationary blade to shear the string of hair.

### BACKGROUND OF INVENTION

1. Field of Invention

The present invention relates to a hair cutter and, more particularly, to a hair cutter for cutting only a few strings of hair at a time.

2. Related Prior Art

Gray hair is symbolic of age, and people look older with gray hair than without. Hence, people tend to cut or pull gray hair if there is a little or dye gray hair if there is a lot. It is however unhealthy to pull gray hair because it hurts hair follicles and hence suppresses the growth of new hair and jeopardizes the quality of new hair. Hence, cutting is preferred to pulling. A pair of scissors can be used to cut gray hair. However, it is almost inevitable to cut other hair than gray hair with a pair of scissors, and this is bothering.

Therefore, the present invention is intended to obviate or at least alleviate the problems encountered in prior art.

### SUMMARY OF INVENTION

It is the primary objective of the present invention to provide a hair cutter for cutting only a few strings of hair at a time.

To achieve the foregoing objective, the hair cutter includes a stationary blade and a movable blade. The stationary blade includes a recess near a free end and a cutting edge on an upper side of the recess. The recess is adapted for receiving at least one string of hair. The movable blade includes a cutting edge at a free end. The cutting edge of the movable blade is movable past the cutting edge of the stationary blade to shear the string of hair.

Other objectives, advantages and features of the present invention will be apparent from the following description referring to the attached drawings.

### BRIEF DESCRIPTION OF DRAWINGS

The present invention will be described via detailed illustration of four embodiments referring to the drawings wherein:

FIG. 1 is a perspective view of a hair cutter according to the first embodiment of the present invention;

FIG. 2 is a cross-sectional view of the hair cutter shown in FIG. 1;

FIG. 3 is a cross-sectional view of the hair cutter in another position than shown in FIG. 2;

FIG. 4 is a perspective view of a hair cutter according to the second embodiment of the present invention;

FIG. 5 is a perspective view of a hair cutter according to the third embodiment of the present invention;

FIG. 6 is a perspective view of a hair cutter according to the fourth embodiment of the present invention; and

FIG. 7 is a cross-sectional view of the hair cutter shown in FIG. 6.

### DETAILED DESCRIPTION OF PREFERRED EMBODIMENT

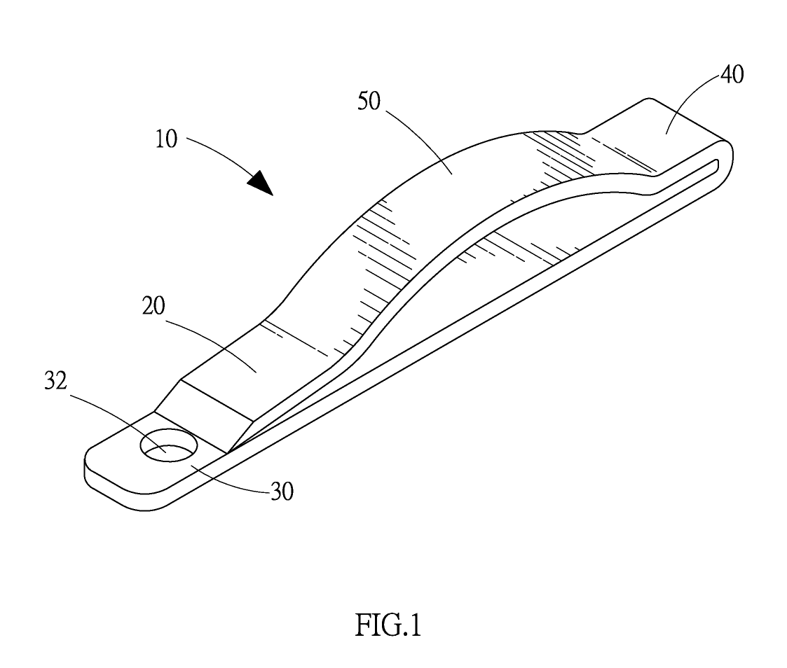

Referring to FIGS. 1 to 3, there is a hair cutter 10 according to a first embodiment of the present invention. The hair cutter 10 includes a movable blade 20, a stationary blade 30, a U-shaped portion 40 and an arched portion 50. Preferably, the hair cutter 10 is a one-piece element that is made of a single strip of steel for example. That is, the movable blade 20, the stationary blade 30, the U-shaped portion 40 and the arched portion 50 are one. The U-shaped portion 40 is formed between the arched portion 50 and the stationary blade 30. The arched portion 50 is formed between the U-shaped portion 40 and the movable blade 20.

The movable blade 20 includes a cutting edge 22 formed at a free end. The cutting edge 22 is in contact with the stationary blade 30.

The stationary blade 30 includes an aperture 32 near a free end. The aperture 32 is preferably a circular aperture with a diameter only a few times as large as that of a string of hair. The diameter of the aperture 32 may be constant throughout its axis or get smaller in an upward direction. Either way, an upper edge 36 of the aperture 32 is used as a cutting edge. The cutting edges 36 and 22 are used for cutting and, more particularly, shearing hair.

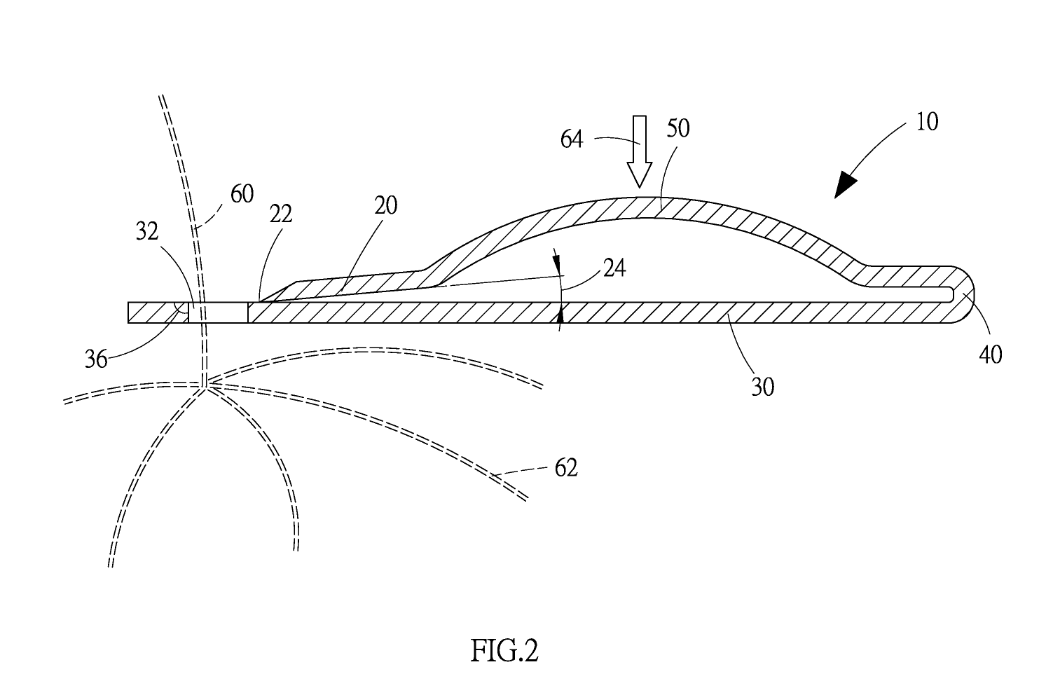

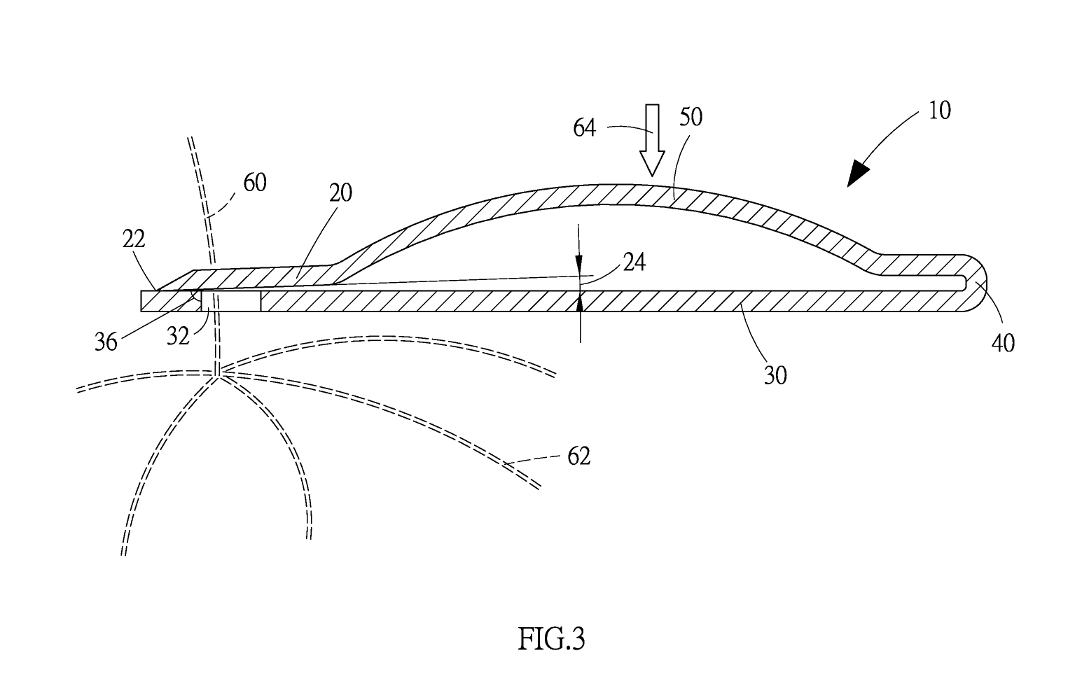

Referring to FIGS. 2 and 3, there is an angle 24 between the movable blade 20 and the stationary blade 30. The angle 24 is selected so that it is always larger than zero degree although it gets smaller as the cutting edge 22 moves toward the aperture 32, i.e., into the position shown in FIG. 3 from the position shown in FIG. 2. Thus, the cutting edge 22 is kept in contact with the stationary blade 30.

In use, a string 60 of gray hair is inserted in the aperture 32 while other strings 62 of hair are placed below the stationary blade 30. The insertion of the string 60 of gray hair into the aperture 32 is in a longitudinal direction. The arched portion 50 is moved toward the stationary blade 30 as indicated by an arrow head 64. Thus, the cutting edge 22 is moved toward the aperture 32. Finally, the cutting edges 22 and 36 together shear the string 60 of gray hair.

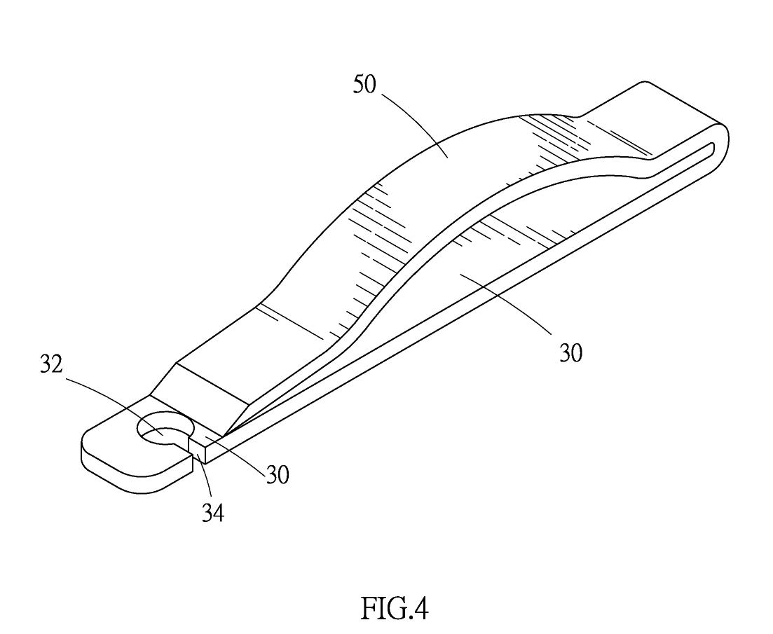

Referring to FIG. 4, there is a hair cutter according to a second embodiment of the present invention. The second embodiment is like the first embodiment except including a cutout 34 in communication with the aperture 32. The insertion of the string 60 of gray hair into the aperture 32 through the cutout 34 may be in a transverse or longitudinal direction. Hence, it is easier to place the string 60 of gray hair in the aperture 32 with the cutout 34 than without.

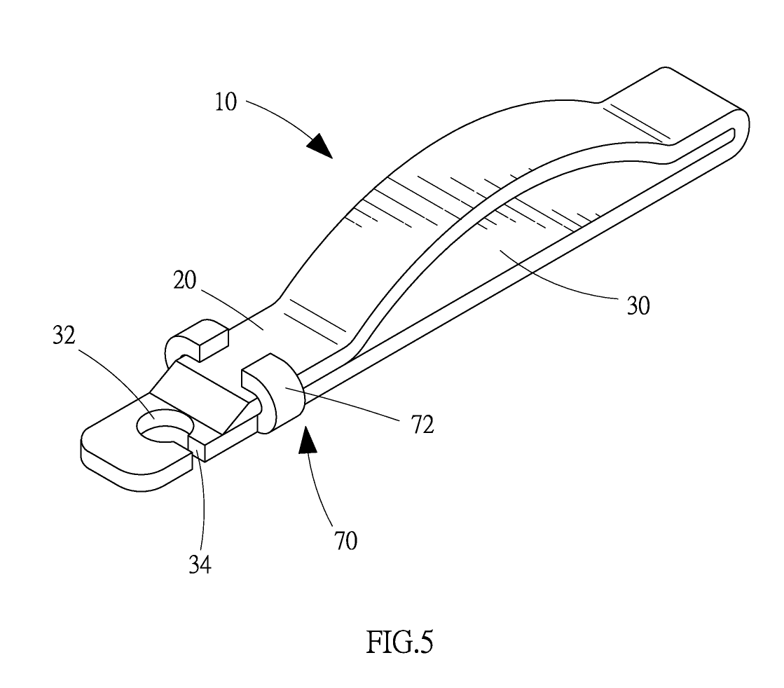

Referring to FIG. 5, there is a hair cutter according to a third embodiment of the present invention. The third embodiment is like the second embodiment except including a restraining unit 70 for restraining the cutting edge 22 on the stationary blade 30. The restraining unit 70 includes two claws 72 extending from two opposite side of the stationary blade 30. Each of the claws 72 includes a free end placed against the movable blade 20. Thus, the movable blade 20 is prevented from buckling to the left or right or upward.

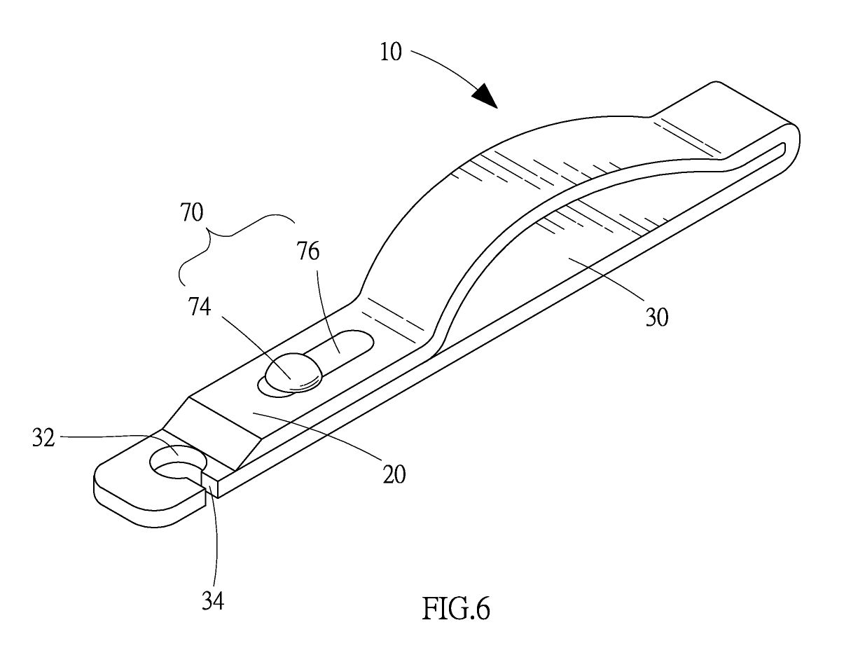

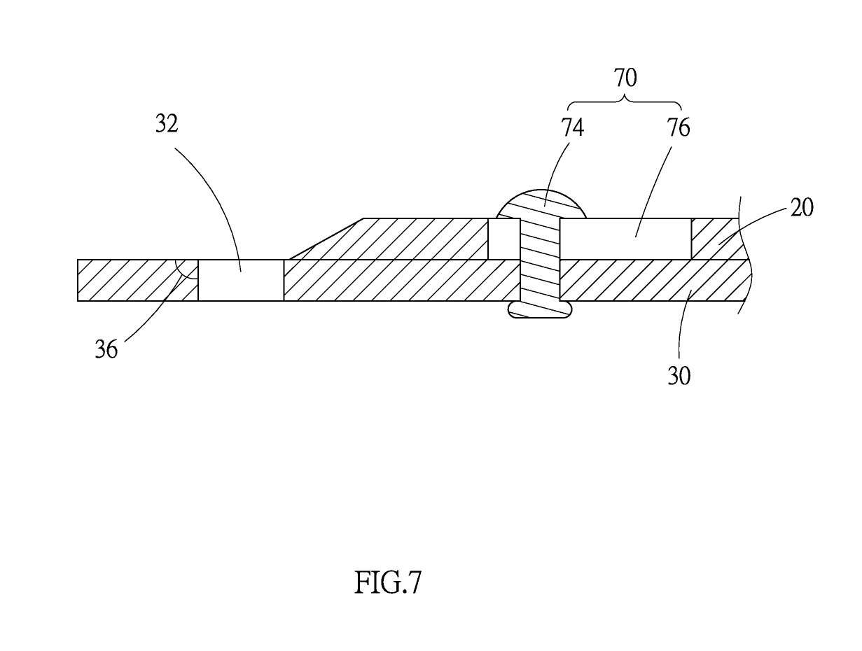

Referring to FIGS. 6 and 7, there is a hair cutter according to a fourth embodiment of the present invention. The fourth embodiment is like the third embodiment except including a rivet 74 and a slot 76 instead of the claws 72. The slot 76 is made in the movable blade 20. The rivet 74 includes a middle portion formed between two enlarged terminal portions. The middle portion of the rivet 74 is inserted in the slot 76 and an aperture made in the stationary blade 30 while the enlarged terminal portions of the same are in contact with the movable blade 20 and the stationary blade 30, respectively. Thus, the slot 76 allows the movable blade 20 to move on the stationary blade 30 while the enlarged terminal portions of the rivet 74 keep the cutting edge 22 in contact with the stationary blade 30.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A hair cutter including:
a stationary blade including an aperture near a free end and a cutting edge on an upper side of the aperture, wherein the aperture is adapted for receiving at least one string of hair; and
a movable blade including a cutting edge at a free end, wherein the cutting edge of the movable blade is movable past the cutting edge of the stationary blade to shear the string of hair.

2. The hair cutter according to claim 1, including a U-shaped portion between the stationary blade and the movable blade.

3. The hair cutter according to claim 2, including an arched portion between the U-shaped portion and the movable blade.

4. The hair cutter according to claim 1, wherein the stationary blade includes a cutout in communication with the aperture to allow the movement of the string of hair into the aperture through the cutout in a transverse direction.

5. The hair cutter according to claim 1, including a restraining unit for restraining the movable blade on the stationary blade.

6. The hair cutter according to claim 5, wherein the restraining unit includes two claws extending from two opposite sides of the stationary blade, wherein each of the claws includes a tip in contact with the movable blade.

7. The hair cutter according to claim 1, wherein the restraining unit includes:
a slot made in the movable blade; and
a rivet formed with a middle potion inserted in the slot and two enlarged terminal portions in contact with the movable blade and the stationary blade, respectively.
